(19) United States
(12) Patent Application Publication
(10) Pub. No.: US 2010/0100446 A1
(43) Pub. Date: Apr. 22, 2010

(54) METHOD FOR ADVERTISING USING MOBILE MULTIPLAYER GAME AND SYSTEM THEREOF

(76) Inventor: Hyong-Suk Kim, Surrey (GB)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/531,090

(22) PCT Filed: Mar. 14, 2007
(86) PCT No.: PCT/KR2007/001248

§ 371 Date: Sep. 14, 2009

(51) Int. Cl. G06Q 30/00; H04W 4/00

(52) U.S. Cl. 705/14.64; 455/414.1

(57) ABSTRACT

A method of advertising using a multiplayer game for a mobile device, comprising: transmitting/receiving data for executing the multiplayer game in the mobile device through a network channel; checking whether a user of the multiplayer game has paid to play the multiplayer game! and determining whether or not to display an advertisement on a screen of the mobile device for the multiplayer game based on the check result and whether or not a free trial period has expired.

### TECHNICAL FIELD

The present invention relates to a method of advertising using a mobile multiplayer game and a system thereof. More particularly, the present invention relates to a method and a system for advertising by displaying an advertisement on a screen of a mobile device for the multiplayer game when a user of the multiplayer game has not paid to play the multiplayer game, and removing the advertisement on the screen when the user has paid to play the multiplayer game.

### BACKGROUND ART

Nowadays, mobile technology is being rapidly developed. Thus, various mobile devices, such as cellular phones and personal digital assistants (PDA), are widely used. Users of the mobile devices may use various contents, such as games, e-learning and e-banking, using the mobile devices.

As the number of the users of the mobile devices are increasing, various marketing methods using the mobile devices are emerging. For example, some marketing methods use online coupons, Wireless Application Protocol (WAP) banners, displaying advertisements according to users' locations, etc.

One of the marketing methods using the mobile devices is to use a short message service (SMS) of a cellular phone. In the marketing method using the SMS, a short message advertising a product or a service is transmitted to the user of a mobile device. The size of text data that can be transmitted during one transmission, however, is limited to a predetermined size, and only text data may be transmitted. Thus, various types of advertisements may not be provided using the SMS.

Additionally, the efficiency of the advertisement may decrease when the user unsubscribes from receiving further advertisement messages. Indiscreetly transmitting advertisement messages may irritate users and leave bad impressions about the product and the service being advertised.

Thus, a method of advertising capable of inducing users to naturally accept various types of advertisements is required. Additionally, a business model providing appropriate advertisements selected based on preferences of the users and capable of making a profit in association with advertisement providers is required.

### DISCLOSURE OF THE INVENTION

### Technical Problem

The present invention provides a method and a system for advertising by displaying an advertisement on a screen of a mobile device for a multiplayer game when a user of the multiplayer game has not paid to play the multiplayer game, and removing the advertisement on the screen when the user has paid to play the multiplayer game.

The present invention provides a method and a system for advertising by displaying an advertisement appropriately selected according to member information of a user.

### Technical Solution

Accordingly, the present invention is provided to substantially obviate one or more problems due to limitations and disadvantages of the related art.

In an example embodiment of the present invention, a method of advertising using a multiplayer game for a mobile device comprises transmitting/receiving data for executing the multiplayer game in the mobile device through a network channel, checking whether a user of the multiplayer game has paid to play the multiplayer game, and determining whether or not to display an advertisement on a screen of the mobile device for the multiplayer game based on the check result and whether or not a free trial period has expired.

In another example embodiment of the present invention, an advertisement system using a multiplayer game for a mobile device comprises a mobile multiplayer game management unit and a mobile advertisement management unit. The mobile multiplayer game management unit transmits/receives data required for playing the multiplayer game through a network channel. The mobile advertisement management unit is associated with the mobile multiplayer game management unit. The mobile advertisement management unit checks whether or not a user of the multiplayer game has paid to play the multiplayer game, determines whether or not to display the advertisement on a screen of the mobile device for the multiplayer game, and controls data transmission for displaying the advertisement.

In still another embodiment of the present invention, an advertisement management server comprises a memory, a processor and a transmitter. The memory stores a mobile advertisement management program for controlling whether or not to display an advertisement on a screen of a mobile device for a multiplayer game, and an advertisement type, based on whether or not a user of the multiplayer game has paid to play the multiplayer game. The processor control functions of the mobile advertisement management program. The transmitter/receiver unit transmits/receives data through the communication network to determine whether or not to display the advertisement on the screen and the advertisement display type.

In still another embodiment of the present invention, a mobile device comprises a memory, a control unit, a transmitter/receiver unit, a keypad and a display unit. The memory stores a multiplayer game having an advertising function to control whether or not to display an advertisement and an advertisement display type in response to a control signal received from a mobile advertisement management unit. The control unit executes the multiplayer game and controls the advertising function. The transmitter/receiver unit transmits/receives data to the mobile advertisement management unit through a communication network. The transmitter/receiver unit is controlled by the control unit. A keypad operates the multiplayer game. The display unit displays the multiplayer game and the advertisement.

### BRIEF DESCRIPTION OF THE DRAWINGS

The above and other advantages of the present invention will become more apparent by describing in detail example embodiments thereof with reference to the accompanying drawings, in which:

FIG. 1 is a flowchart briefly illustrating a method of advertising using a multiplayer game.

FIG. 2 is a flowchart illustrating in detail a method of advertising using a multiplayer game.

FIG. 3 is a flowchart illustrating a procedure for registering member information.

FIGS. 4 through 6 are interface screens of a mobile device for illustrating a method of advertising according to an example embodiment.

FIGS. 7 through 9 are interface screens of a mobile device for illustrating a procedure for registering member information and displaying the advertisement using the member information.

FIGS. 10 through 12 are interface screens of the mobile device for illustrating various advertising methods.

FIGS. 13 through 14 are interface screens for illustrating a credit card payment system.

FIG. 15 is a structural diagram illustrating an advertisement system using the multiplayer game.

FIG. 16 is a block diagram illustrating the structure of a mobile advertisement management server performing the method of advertising using the multiplayer game.

FIG. 17 is a block diagram illustrating the structure of a mobile device for displaying the advertisement using the multiplayer game.

### BEST MODE FOR CARRYING OUT THE INVENTION

Hereinafter, the present invention will be described in detail with reference to the accompanying drawings. In the drawings, like numbers refer to like elements. In a case where a detailed description may make the subject matter unclear, the detailed description will be omitted.

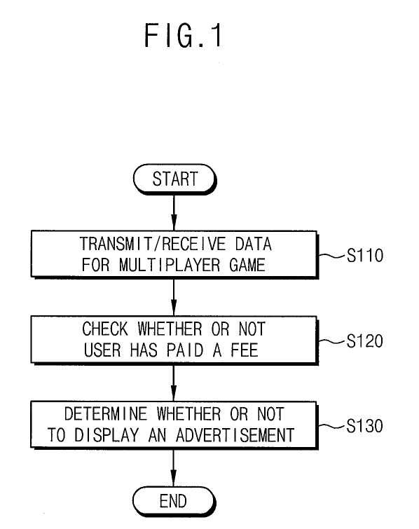

FIG. 1 is a flowchart briefly illustrating a method of advertising using a multiplayer game.

Referring to FIG. 1, the method of advertising according to an example embodiment of the present invention uses a multiplayer game for a mobile device. Thus, data required by users of a plurality of mobile devices to play the multiplayer game is transmitted and received (step S110). Herein, an advertisement may be displayed on a screen of the mobile device for the multiplayer game. A plurality of advertisement providers may advertise their products or services using the multiplayer game to naturally induce the users of the multiplayer game to be interested in their products and services. Whether or not to display the advertisement on the screen may be determined according to whether or not a user has paid to play the multiplayer game because indiscreetly displaying the advertisement on the screen may irritate the user. In an example embodiment of the present invention, whether or not the user of the multiplayer game has paid to play the multiplayer game is checked before the user starts playing the multiplayer game (step S120). Whether or not to display an advertisement on a screen of the mobile device for the multiplayer game is determined based on the check result and whether or not a free trial period has expired (step S130). A fee for playing the multiplayer game may correspond to a fee for removing the advertisement on the screen.

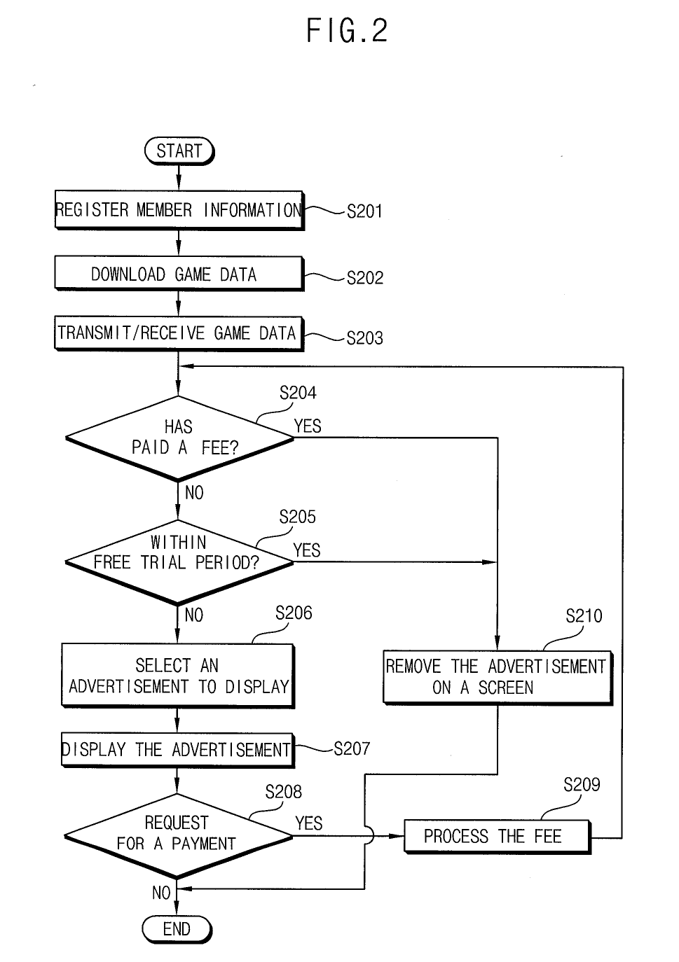

FIG. 2 is a flowchart illustrating in detail a method of advertising using a multiplayer game.

Referring FIG. 2, the method of advertising using the mobile device may include registering member information of the user of the multiplayer game (step S201). The advertisement to be displayed on the screen is selected using the member information of the user. Selecting the advertisement for display on the screen using the member information may increase advertisement efficiency. The member information may also be used in processing data required for the multiplayer game.

In an example embodiment, the multiplayer game may be downloaded from a server (step S202). In another example embodiment, the method of advertising may use a multiplayer game initially embedded in the mobile device. By implementing a downloadable game, the multiplayer game may be easily updated as the mobile device and games system are developed, and various kinds of multiplayer games may be used for advertising.

The method of advertising includes steps of executing general functions for playing the multiplayer game because the method of advertising shows the advertisement to the user of the multiplayer game. Executing general functions may include transmitting/receiving data required for playing the multiplayer game (step S203).

Whether or not the user has paid to play the multiplayer game is checked before the user starts playing the multiplayer game or when the user plays the multiplayer game (step S204). Whether or not to display the advertisement may be determined based on whether or not the user has paid to play the multiplayer game. Herein, additional conditions may be applied to determine whether or not to display the advertisement. In an example embodiment of the present invention, the user may play the multiplayer game for a free trial period even if the user has not paid to play the multiplayer game. Thus, determining whether or not to display the advertisement may further include checking whether or not the user plays the multiplayer game within the free trial period (step S205). The free trial period may help to increase the number of initial users of the multiplayer game and may help the user to easily decide whether or not to purchase the multiplayer game.

The advertisement on the screen may be removed and the user may play the multiplayer game without the advertisement when the user has paid to play the multiplayer game or the free trial period has not yet expired (step S210). (In this specification, “removing the advertisement” means “not displaying the advertisement.”)

The advertisement to be displayed on the screen of the mobile device for the multiplayer game is selected when the user has not paid to play the multiplayer game and the free trial period has expired (step S206). A plurality of advertisements may be provided from a plurality of advertisement providers. Thus, advertisement efficiency may be increased by selecting an appropriate advertisement among the plurality of the advertisements using member information of the user. Data for selected advertisement is transmitted to the mobile device to display the advertisement on the screen (step S207).

In an example embodiment, the method of advertising may include processing the fee the user has paid in response to a request for payment. The fee is processed (step S209) when the user has paid to play the multiplayer game (step S208). Various methods of processing the fee may be performed with various implementations according to example embodiments. In an example embodiment, the fee may be processed with a credit card payment system. The user may pay for the fee using the credit card payment system on a web site designated on the screen of the mobile device. The fee may be imposed as a game fee, a data fee, a short message service (SMS) fee, or an automatic response system (ARS) fee. The multiplayer game may be played without the advertisement when the fee is successfully processed.

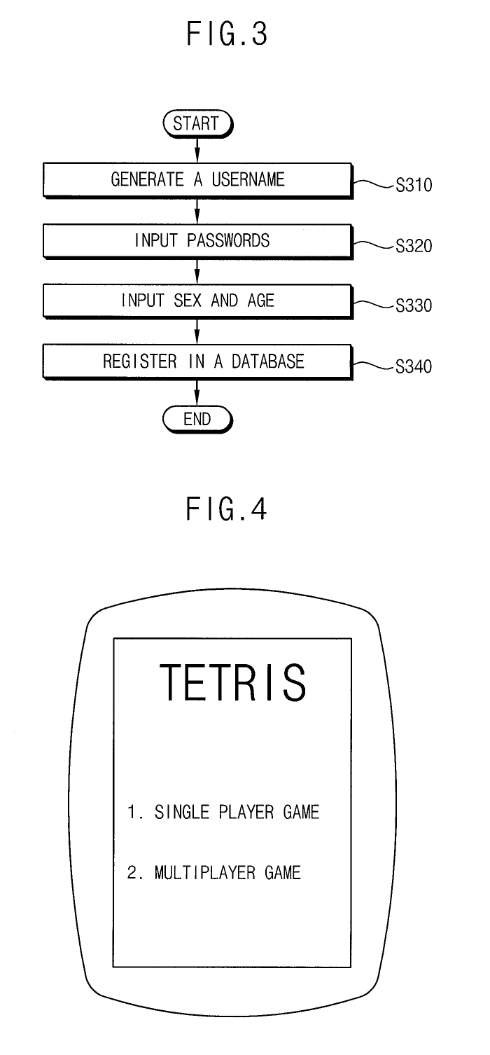

FIG. 3 is a flowchart illustrating a procedure for registering member information.

Referring to FIG. 3, registering member information may include generating a username for the user (step S310), receiving a password input by the user (step S320), receiving information about sex and age (step S330), and registering input data in a database (step S340).

The username may be selected by the user or allocated automatically for convenience. The password may be input to recognize the user. In an example embodiment, additional information with the username and password may be input. The additional information may include a user's sex, age, country of residence, language, hobbies and preferences. The additional information may be used to select the advertisement to be displayed on the screen of the mobile device. Thus, the advertisement efficiency may increase by selecting an appropriate advertisement. The member information of the user used to select the advertisement and check whether or not the user has paid to play the multiplayer game may be registered in the database (step S340).

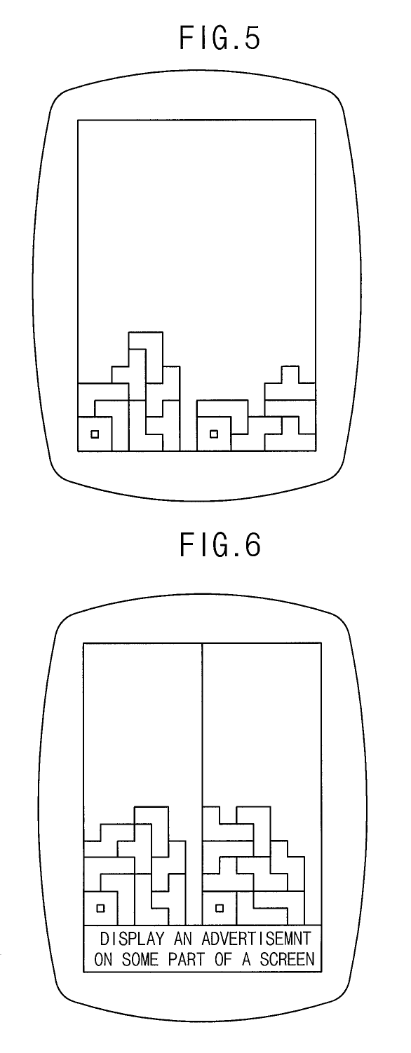

FIGS. 4 through 6 are interface screens of a mobile device for illustrating a method of advertising according to an example embodiment.

FIG. 4 is a screen of a game having both of a single player mode and a multiplayer mode. In an example embodiment, displaying the advertisement using the game having both of the multiplayer mode and the single player mode may increase advertisement efficiency.

The single player or multiplayer game may initially be embedded in the mobile device or may be downloaded from a server. The multiplayer game or the single player game may be implemented in various programming languages such as C/C++, Java or Flash.

FIG. 5 is a screen of a game in the single player mode.

In the single player mode in FIG. 5, the user may play a game against the artificial intelligence (AI) of a computer in a mobile device without other users connecting to the game. The user may play a demo version in a single player mode. Then, the user may play a full version game when the user has paid to play the full version game after requesting the full version game.

FIG. 6 is a screen of a game in the multiplayer mode.

Referring to FIG. 6, in the multiplayer mode, the use may play with AI as well as other users. The advertisement may be displayed in a lower part of the screen of the mobile device. Advertisement efficiency may be increased in the multiplayer mode because more users are required in the multiplayer mode than the single player mode.

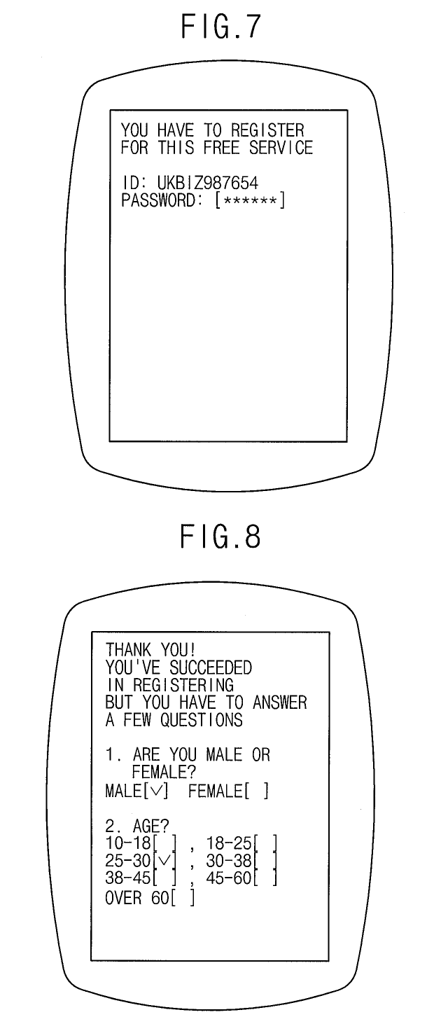

FIGS. 7 through 9 are interface screens of a mobile device for illustrating a procedure for registering member information and displaying the advertisement using the member information.

FIG. 7 illustrates steps of generating the username and receiving the password. The username may be automatically allocated to the user for convenience. The password may be selected by the user. For example, a password may include 4-6 digit numbers. The password may be represented as asterisks (*) when the user inputs the password so as not to expose the password to others.

FIG. 8 is a screen for receiving additional information from the user.

Referring FIG. 8, in an example embodiment, the additional information may be received by requesting answers for simple questions. For example, a user's sex, age, country of residence, language, hobbies and preferences may be collected. The collected additional information may be used to select the advertisement to be displayed on a screen of the mobile device.

FIG. 9 is an interface screen of the mobile device to display the selected advertisement using the member information.

Referring FIG. 9, the advertisement may be selected using member information collected in steps described with FIGS. 7 through 9. The selected advertisement is displayed on some part of the screen of the mobile device. For example, an advertisement such as that for a “Nintendo Wii” may be displayed when the user is a man in his teens. An advertisement of a fashion brand such as “Prada” may be displayed when the user is a woman in her twenties. When the user clicks the displayed advertisement, a screen may display detailed product information. A place where the user may purchase the product displayed on the screen. The user may purchase the product directly using the mobile device.

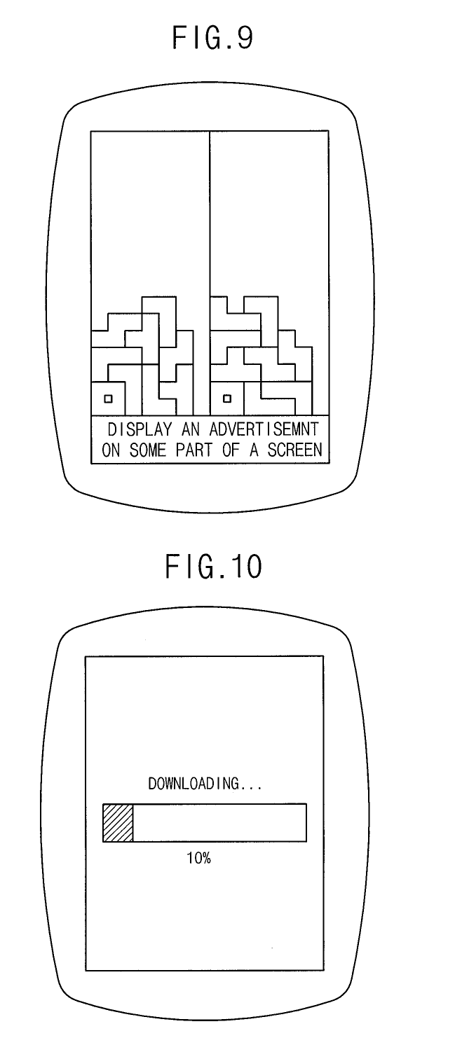

FIGS. 10 through 12 are interface screens of the mobile device for illustrating various advertising methods.

FIG. 10 illustrates a procedure for downloading the multiplayer game from a server. The multiplayer game may initially be embedded in the mobile device or downloaded from a server. The amount of downloaded data may be displayed on the screen as a percentage.

FIG. 11 is a screen displaying the advertisement on a full screen.

Referring to FIG. 11, the advertisement may be displayed on the full screen before the user starts playing the multiplayer game when the user has not paid to play the multiplayer game. The user may be forced to watch the advertisement because the advertisement is displayed on the full screen for a short time. The advertisement may be displayed with images and sound if the mobile device supports sound. The advertisement may be displayed as a video, such as a commercial similar to that shown on television (TV).

FIG. 12 illustrates a screen displaying the advertisement on some part of the screen.

The advertisement may be displayed on some part of the screen continuously when the user plays the multiplayer game. The advertisement may be displayed for a longer time when the advertisement is displayed on some part of the screen than being displayed on the full screen. Various advertisements may be alternately displayed.

When the user clicks the displayed advertisement or presses a specific key, a screen may show detailed product information. The user may purchase the product directly using the mobile device. The advertisement may not be displayed on the screen when the user has not paid to play the multiplayer game.

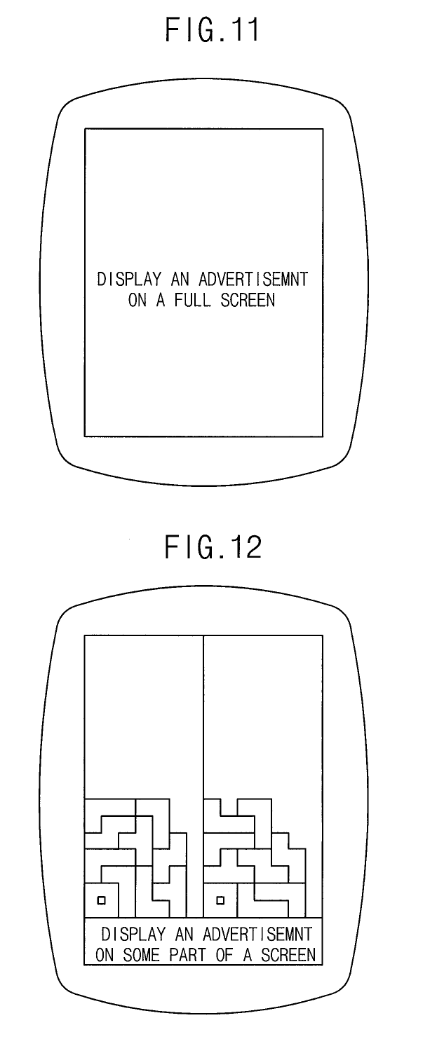

FIGS. 13 through 14 are interface screens for illustrating a credit card payment system.

In an example embodiment, the method of advertising may include processing the fee when the user has paid to play the multiplayer game without advertisement. The fee is processed with a credit card payment system. The user may request payment using an SMS message. Then, information including a usage period of the multiplayer game and a Uniform Resource Locator (URL) address for the credit payment may be displayed on the screen. The user may pay for the multiplayer game using a credit card on the web site designated on the screen. The fee for playing the multiplayer game may be imposed once or many times periodically.

FIG. 14 is a screen for playing the multiplayer game by the user after paying the fee.

Referring to FIG. 14, the user may access the multiplayer game after inputting the username and the password. A server checks whether or not the user has paid the fee. The advertisement may not be displayed on the screen when the user has paid the fee. The advertisement may not be displayed on a lower part of the screen either when the user plays the multiplayer game when after user has paid the fee.

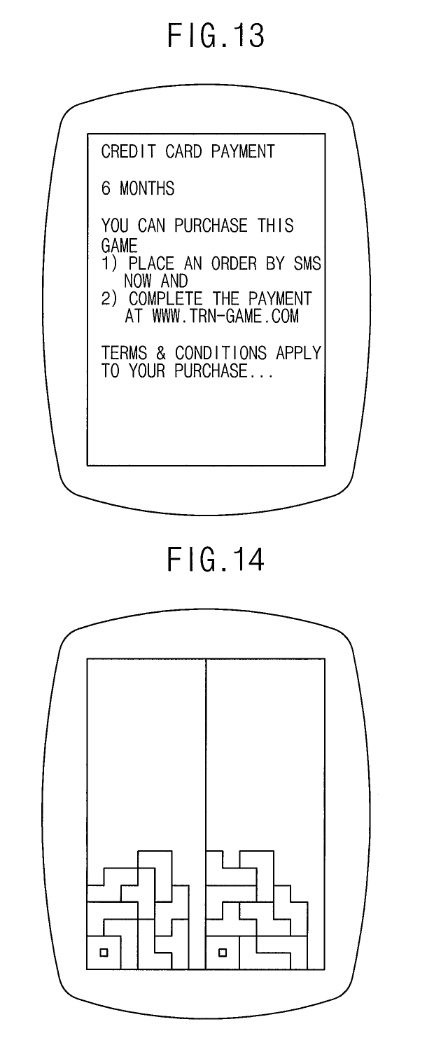

FIG. 15 is a structural diagram illustrating an advertisement system using the multiplayer game.

Referring to FIG. 15, the advertisement system include a mobile game management unit MGMS, and a mobile advertisement management unit MAMS. The advertisement system may further include one or more mobile devices MD1-MD3.

The mobile multiplayer game management unit MGMS performs operations required for playing the multiplayer game. The mobile multiplayer game management unit MGMS transmits/receives data required for playing the multiplayer game by forming a network channel with the mobile devices MD1-MD3. The network channel associated with the mobile multiplayer game management unit MGMS and the mobile devices MD1-MD3 may be one of various types of wireless communication channels.

The mobile advertisement management unit MAMS interacts with the mobile multiplayer game management unit MGMS to control the advertisement to be displayed on the screen. The mobile advertisement management unit MAMS checks whether or not the user of the multiplayer game has paid to play the multiplayer game. The mobile advertisement management unit MAMS does not display the advertisement on the screen when the user has paid the fee. The mobile advertisement management unit MAMS displays the advertisement on the screen when the user has not paid the fee. Herein, the mobile advertisement management unit MAMS may select the advertisement among advertisements provided from the advertisement providers NAS1-NAS3. Selecting the advertisement using the member information of the user may be efficient. The advertisement system or the mobile multiplayer game management unit may further include a database management unit (not shown) for registering and searching for the member information.

The advertisement providers NAS1-NAS3 interact with the mobile advertisement management unit to provide information about the advertisements. The advertisement providers NAS1-NAS3 may be implemented with servers in an advertisement agency. One mobile advertisement management unit may interact with a plurality of advertisement providers NAS1-NAS3 to receive the advertisements.

The advertisement providers NAS1-NAS3 and the mobile advertisement management unit MGMS may use a common application programming interface (API) for transmitting data for communication. For example, the mobile advertisement management unit MAMS may request at least one of the advertisement providers NAS1-NAS3 using a format such as “NEO,1520M,DB05,MZTSOND900,UK”. Herein, “NEO” represents the username, and “1520M” represents that the user is a 15 to 20-year-old man. “DB05” represents information about a hobby of the user. “MZTSOND900”represents information about a name, a developer and a style of the multiplayer game. “UK” represents that the user is accessing the system from the United Kingdom. The advertisement providers NAS1-NAS3 provide information about an advertisement using a format such as “AP01,AD000000456789,01,UK”. Herein, “AP01” represents an advertisement provider number, which is “01” in this case (NAS1). “AD000000456789” represents an advertisement number. “01” represents the style of the advertisement and “UK” represents that the advertisement is related to the United Kingdom.

The format of the data transmitted between the advertisement providers NAS1-NAS3 and the mobile advertisement management unit MGMS may be defined in various ways.

The plurality of the mobile devices MD1-MD3 may access a base station using methods such as Global System for Mobile communications (GSM), General Packet Radio Service (GPRS), Universal Mobile Telecommunications System (UMTS), Code Division Multiple Access (CDMA), or Wi-Fi. The mobile device executes the multiplayer game and displays the advertisement while connecting to the mobile multiplayer game management unit MGMS and the mobile advertisement management unit MAMS.

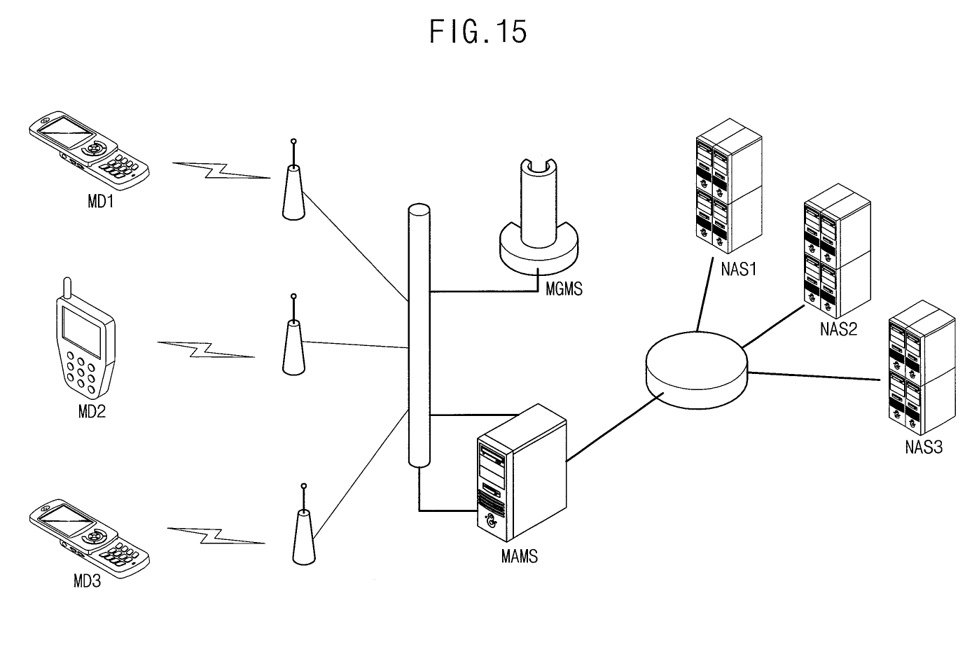

FIG. 16 is a structural diagram of a mobile advertisement management server performing the method of advertising using the mobile device.

Referring to FIG. 16, the mobile advertisement management server includes a memory 1610, a processor 1620 and a transmitter/receiver unit 1640.

The memory 1610 stores the mobile advertisement management program MAMP. The mobile advertisement management program controls whether or not to display the advertisement, and the display type, based on whether or not the user has paid to play the multiplayer game.

The processor 1620 executes the mobile advertisement management program MAMP stored in the memory 1610.

A transmitter/receiver 1640 transmits/receives data for controlling whether or not to display the advertisement and a display type on the screen of the mobile device, in response to the processor 1620.

The mobile advertisement management server may further include a database 1630 for managing member information of the user. The member information 1630 stored in the database may be used to selected the advertisement to be displayed on the screen. Appropriate advertisement may be selected using the member information including the sex and the age.

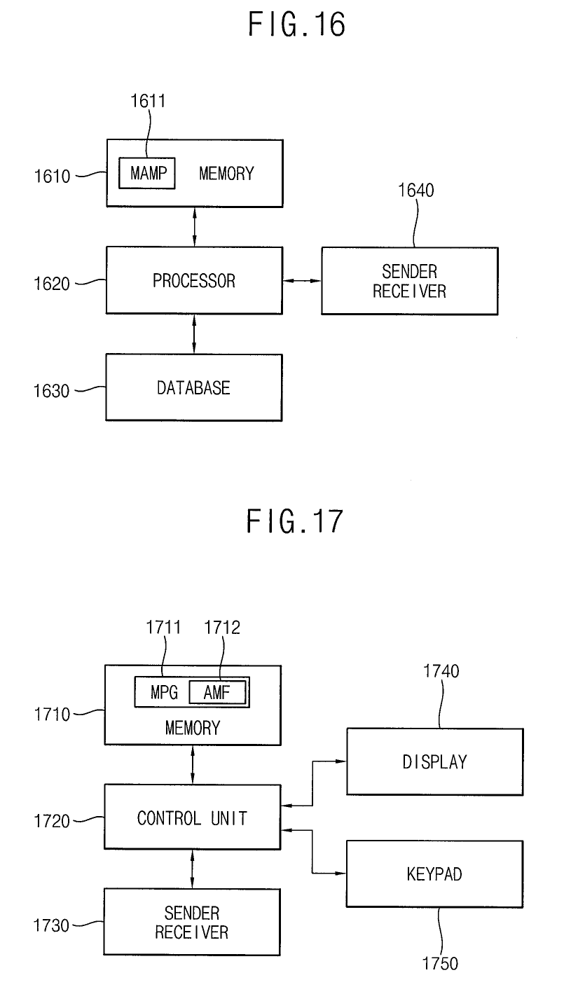

FIG. 17 is a diagram illustrating the structure of the mobile device for displaying the advertisement using the multiplayer game.

The mobile device according to an example embodiment may be a personal digital assistant (PDA), a cellular phone, a Personal Communication Service (PCS) phone, a GSM phone, a Wideband CDMA (W-CDMA) phone, a CDMA-2000 phone, a Mobile Broadband System (MBS) phone, etc.

Referring to FIG. 17, the mobile device according to an example embodiment includes a memory 1710, a control unit 1720, a transmitter/receiver unit 1730, a display unit 1740 and a keypad 1750.

The memory 1710 stores the multiplayer game MPG The multiplayer game includes a function AMF for controlling to display the advertisement. Thus, advertisement may be controlled during gameplay. A program having functions to control only displaying the advertisement may be used.

The transmitter/receiver unit 1730 transmits/receives data for controlling to display the advertisement and data for playing the multiplayer game.

The control unit 1720 executes a multiplayer game and controls whether or not to display the advertisement on the display unit 1740, and display type, in response to display control data received through the transmitter/receiver 1730.

The display unit 1740 displays the multiplayer game and the advertisement. The user may operate the multiplayer game and input the member information using a keypad 1750.

### INDUSTRIAL APPLICABILITY

As described above, a method and a system for advertising using the multiplayer game displays an advertisement on a screen of a mobile device when a user of the multiplayer game has not paid to play the multiplayer game, and removes the advertisement on the screen when the user has paid to play the multiplayer game. Thus, a plurality of advertisement providers may advertise their products or services using the multiplayer game to naturally induce the user of the multiplayer game to be interested in their products and services.

Additionally, advertisement efficiency may be increased by selecting appropriate advertisement among the plurality of the advertisements using member information of the user.

While the present invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims.

1. A method of advertising using a multiplayer game for a mobile device, comprising:
transmitting/receiving data for executing the multiplayer game in the mobile device through a network channel;
checking whether a user of the multiplayer game has paid to play the multiplayer game; and
determining whether or not to display an advertisement on a screen of the mobile device for the multiplayer game based on the check result and whether or not a free trial period has expired.

2. The method of claim 1, wherein determining whether or not to display the advertisement comprises:
removing the advertisement on the screen of the mobile device for the multiplayer game when the user has paid to play the multiplayer game.

3. The method of claim 2, wherein determining whether or not to display the advertisement comprises:
displaying the advertisement on the screen of the mobile device for the multiplayer game when the user has not paid to play the multiplayer game and the free trial period has expired.

4. The method of claim 3, wherein the advertisement is displayed on a full screen before the user starts playing the multiplayer game.

5. The method of claim 3, wherein the advertisement is displayed on some part of the screen when the user plays the multiplayer game.

6. The method of claim 3, wherein the advertisement comprises images and sounds.

7. The method of claim 1, further comprising:
registering member information of the user; and
selecting the advertisement, for display on the screen of the mobile device for the multiplayer game among a plurality of advertisements provided from advertisement providers, based on the member information of the user of the multiplayer game.

8. The method of claim 7, wherein registering the member information of the user comprises:
generating a username for the user; and
receiving a password input by the user.

9. The method of claim 8, wherein registering the member information of the user further comprises:
receiving personal information input by the user including sex and age;
receiving preferences input by the user; and
storing the personal information and the preferences in a database.

10. The method of claim 1, wherein the multiplayer game is initially embedded in the mobile device or downloadable from a server.

11. The method of claim 1, wherein a fee for playing the multiplayer game is repeatedly imposed for every predetermined period.

12. The method of claim 1, further comprising processing the fee paid by the user for playing the multiplayer game.

13. The method of claim 12, wherein the fee is processed with a credit card payment system.

14. The method of claim 13, wherein the credit card payment system is utilized on a web site.

15. The method of claim 14, wherein data required for processing the fee is transmitted through a short message service (SMS) message.

16. An advertisement system using a multiplayer game for a mobile device, comprising:
a mobile multiplayer game management unit configured to transmit/receive data required for playing the multiplayer game through a network channel; and
a mobile advertisement management unit configured to be associated with the mobile multiplayer game management unit, check whether or not a user of the multiplayer game has paid to play the multiplayer game, determine whether or not to display the advertisement on a screen of the mobile device for the multiplayer game, and control data transmission for displaying the advertisement.

17. The advertisement system of claim 16, further comprising at least one advertisement provider providing the advertisement to the mobile advertisement management unit.

18. The advertisement system of claim 17, wherein the mobile advertisement management unit selects the advertisement for display on the screen among a plurality of the advertisements provided from the at least one advertisement provider, based on member information of the user of the multiplayer game.

19. The advertisement system of claim 17, wherein the mobile advertisement management unit and the advertisement provider use a common application programming interface (API) for transmitting data for displaying the advertisement.

20. The advertisement system of claim 16, wherein the mobile multiplayer game management unit, the mobile advertisement management unit and the mobile device communicate with one another using Global System for Mobile communications (GSM), General Packet Radio Service (GPRS), Code Division Multiple Access (CDMA), or Wi-Fi.

21. The advertisement system of claim 16, further comprising a fee processing unit configured to process the fee when the user pays the fee.

22. The advertisement system of claim 21, wherein the fee processing unit corresponds to a credit card payment system.

23. The advertisement system of claim 22, wherein the credit card payment system is utilized on a web site.

24. An advertisement management server comprising:
a memory configured to store a mobile advertisement management program for controlling whether or not to display an advertisement on a screen of a mobile device for a multiplayer game, and an advertisement type, based on whether or not a user of the multiplayer game has paid to play the multiplayer game;
a processor configured to control functions of the mobile advertisement management program; and
a transmitter/receiver unit configured to transmit/receive data through the communication network to determine whether or not to display the advertisement on the screen and the advertisement display type.

25. The advertisement management server of claim 24, wherein the mobile advertisement management program removes the advertisement on the screen of the mobile device for the multiplayer game when the user has paid to play the multiplayer game.

26. The advertisement management server of claim 25, wherein the mobile advertisement management program displays the advertisement on the screen of the mobile device for the multiplayer game when the user has not paid to play the multiplayer game and a free trial period has expired.

27. The advertisement management server of claim 24, further comprising a database management unit configured to manage member information of the user of the multiplayer game.

28. The advertisement management server of claim 27, wherein the mobile management program selects the advertisement for display on the screen of the mobile device for the multiplayer game among a plurality of advertisements, based on the member information of the user of the multiplayer game.

29. The advertisement management server of claim 28, wherein the member information of the user comprises a username, a password, sex, age and country of residence.

30. A mobile device comprising:
a memory configured to store a multiplayer game having an advertising function to control whether or not to display an advertisement and an advertisement display type in response to a control signal received from a mobile advertisement management unit;
a control unit configured to execute the multiplayer game and control the advertising function;
a transmitter/receiver unit configured to transmit/receive data to the mobile advertisement management unit through a communication network, the transmitter/receiver unit being controlled by the control unit;
a keypad configured to operate the multiplayer game; and
a display unit configured to display the multiplayer game and the advertisement.

31. The mobile device of claim 30, wherein the advertisement is displayed on a full screen before the user starts playing the multiplayer game.

32. The mobile device of claim 30, wherein the advertisement is displayed on some part of the screen when the user plays the multiplayer game.

33. The mobile device of claim 30, wherein the advertisement comprises images and sounds.

34. The mobile device of claim 30, wherein the mobile advertisement management unit and the mobile device communicate with each other using Global System for Mobile communications (GSM), General Packet Radio Service (GPRS), Code Division Multiple Access (CDMA), or Wi-Fi.

35. The mobile device of claim 30, wherein the multiplayer game is initially embedded in the mobile device or downloadable from a server.

36. The mobile device of claim 35, wherein the multiplayer game is implemented in the Java programming language.
